(19) United States
(12) Patent Application Publication
(10) Pub. No.: US 2020/0302326 A1
(43) Pub. Date: Sep. 24, 2020

(54) SYSTEM AND METHOD FOR CORRECTING BIAS IN OUTPUTS

(71) Applicant: Stratyfy, Inc., New York, NY (US)

(72) Inventors: Dmitry LESNIK, Wiesbaden (DE); Stas CHERKASSKY, Haifa (IL); Laura KORNHAUSER, New York, NY (US); Michael CHERKASSKY, New York, NY (US); Tobias SCHÄFER, New York, NY (US)

(73) Assignee: Stratyfy, Inc., New York, NY (US)

(21) Appl. No.: 16/895,667

(22) Filed: Jun. 8, 2020

Related U.S. Application Data
(63) Continuation-in-part of application No. 16/644,243, filed on Mar. 4, 2020.
(60) Provisional application No. 62/858,556, filed on Jun. 7, 2019.
(60) Provisional application No. 62/554,152, filed on Sep. 5, 2017.

(51) Int. Cl. G06N 7/00; G06N 20/00

(52) U.S. Cl. CPC G06N 7/005; G06N 20/00

(57) ABSTRACT

A method and system for detecting and correcting of a statistical bias are provided. The method comprising generating a plurality of outputs by a probabilistic rule engine (PRE), each of the plurality of outputs corresponding to an input vector; selecting a group of outputs from the plurality of outputs; determining by the PRE at least one rule, the at least one rule having an impact as measured by a weight of the at least one rule on the output of the group of outputs; and generating a list of the at least one rule sorted by the weight of the at least one rule.

### CROSS-REFERENCE TO RELATED APPLICATIONS

This application claims the benefit of U.S. Provisional Application No. 62/858,556 filed on Jun. 7, 2019. This application is also a continuation-in-part of U.S. patent application Ser. No. 16/644,243 filed Mar. 4, 2020. The U.S. application Ser. No. 16/644,243, which claims priority under 35 U.S.C. § 371 to the International Application No. PCT/IL2018/051103, filed Oct. 14, 2018, which claims the benefit of U.S. Provisional Application No. 62/554,152 filed on Sep. 5, 2017, the contents of which are hereby incorporated by reference.

### TECHNICAL FIELD

The disclosure generally relates to decision engines, and particularly to a system and method for detecting and correcting biased outputs in the decision engines.

### BACKGROUND

Artificial Intelligence (AI) plays a significant role in industry, and is set to increasingly impact life-changing decisions in the future. However, the problem of AI fairness and biases is attracting growing attention. There are a few possible ways to define bias, and how the bias is to be measured. Each of the definitions has its own merits, but also demonstrates some limitations on how it may be applied.

After some way of detecting bias is selected, the next challenge is to mitigate the bias. Most traditional AI methods are by their nature “black-boxes” that allow few information for a human operator to understand the AI's decision making process, let alone how the human operator may influence the decision. A few techniques to reduce bias were proposed, but many have their own drawbacks.

It would therefore be advantageous to mitigate biases that affect the decision made by AI, while preserving the level of performance by AI.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for detecting and correcting of a statistical bias. The method includes generating a plurality of outputs by a probabilistic rule engine (PRE), each of the plurality of outputs corresponding to an input vector, selecting a group of outputs from the plurality of outputs, determining by the PRE at least one rule, the at least one rule having an impact as measured by a weight of the at least one rule on the output of the group of outputs, and generating a list of the at least one rule sorted by the weight of the at least one rule.

Certain embodiments disclosed herein also include a non-transitory computer readable medium having stored thereon instructions for causing a processing circuitry to execute a process. The method includes generating a plurality of outputs by a probabilistic rule engine (PRE), each of the plurality of outputs corresponding to an input vector, selecting a group of outputs from the plurality of outputs, determining by the PRE at least one rule, the at least one rule having an impact as measured by a weight of the at least one rule on the output of the group of outputs, and generating a list of the at least one rule sorted by the weight of the at least one rule.

Certain embodiments disclosed herein further include a system for detecting and correcting of a statistical bias. The system includes a processing circuitry and a memory. The memory includes instructions that, when executed by the processing circuitry, configure the system to generate a plurality of outputs by a probabilistic rule engine (PRE), each of the plurality of outputs corresponding to an input vector, selecting a group of outputs from the plurality of outputs, determine by the PRE at least one rule, the at least one rule having an impact as measured by a weight of the at least one rule on the output of the group of outputs, and generate a list of the at least one rule sorted by the weight of the at least one rule.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic illustration of a probabilistic rule engine (PRE) implemented according to an embodiment.

FIG. 2 is a schematic illustration of a probabilistic rule engine implemented according to an embodiment.

FIG. 3 is a flowchart of a method for identifying and reducing classification disparity in a probabilistic rule based decision engine, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claims. Moreover, some statements may apply to some inventive features but not to others. In general, unless otherwise indicated, singular elements may be in plural and vice versa with no loss of generality. In the drawings, like numerals refer to like parts through several views.

The disclosure deals with a system utilizing a probabilistic rule engine (PRE) for bias detection and correction. The PRE receives input vectors that include a plurality of elements, the contents of which may be populated from the PRE, a user device, third parties, or combinations thereof. For each input vector, a corresponding output is generated by the PRE. The output is generated by applying each rule with a corresponding weight on the input vector. From the generated outputs, a group of outputs is selected, so that each corresponding input vector of the group of outputs includes at least an element common to every input vector. The PRE then determines one or more rules having an impact as measured by a weight of each rule on each output of the group of outputs, and generates a list of the one or more rules sorted by the weight of each rule.

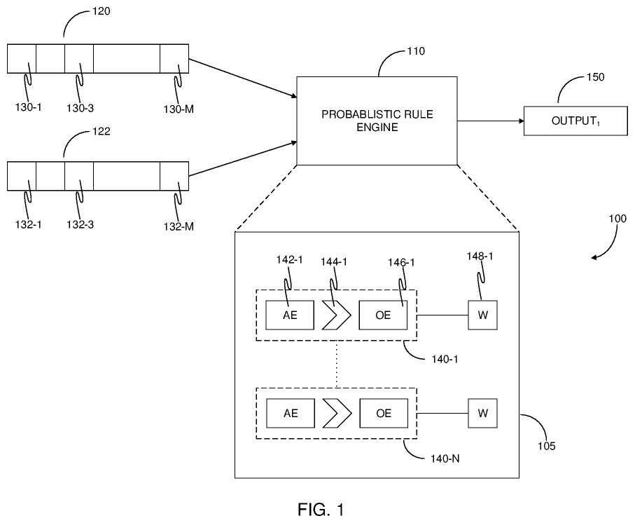

FIG. 1 is a schematic illustration 100 of a probabilistic rule engine (PRE) 110 implemented according to an embodiment. The PRE 110 receives transactional vectors such as transactional vectors 120 and 122. A transactional vector 120,122 includes a plurality of elements, such as elements 130-1 through 130-M (hereinafter referred to as element 130) of vector 120 and elements 132-1 through 132-M (hereinafter referred to as element 132) of vector 122. Each of the elements 130, 132 corresponds to a variable, each variable having one of a plurality of values. The transactional vector 120 may represent, for example, a database transaction. The PRE 110 includes a plurality of rules 140-1 through 140-N (hereinafter referred to as rule 140), for example, for classifying transactions in a transactional database. In this embodiment, ‘M’ and ‘N’ are integer numbers each having a value of ‘1’ or greater.

Classifying transactions may include generating an outcome of the transaction. Each rule 140 includes additional elements, such as one or more attribute elements 142-1 through 140-N (hereinafter referred to as attribute element 142), which may each correspond to a data field (element) of a transaction, and one or more output elements 146-1 through 146-N (hereinafter referred to as output element 146). The rule 140 further includes a condition (or relation) 144-1 through 144-N (hereinafter referred to as condition 144). A condition may be, for example, an “If-Then” condition, or any logical expression, including connectives such as “or,” “and,” etc.

In an embodiment, each rule 140 is further associated with a weight value 148-1 through 148-N (hereinafter referred to as weight value 148) (which may have a different value for each rule 140). The weight value 148 may be static, dynamic, or adaptive. A static weight value is one that is predetermined and remains constant. In contrast, dynamic weight values are values that are forcefully changed, and adaptive weight values are values that are changed in response to a learning process. In some embodiments, rules 140 may have a single element, for example in indicating that a certain attribute is always “true” (or false, depending on the implemented logic). Applying a rule 140 or a set of rules 140 that include the PRE model may yield a score, which in an embodiment is a value representing the probability that the output is “true” (or “false”).

Additionally, the PRE 110 is operative for generating an output 150, such as first output 150. In an embodiment, the PRE 110 may generate a plurality of outputs, each corresponding to a unique input vector.

In an embodiment, an operator of the PRE 110 may wish to avoid bias in decision making. Avoiding bias may be beneficial to an operator of a PRE. Bias may be determined, for example, by selecting a portion of outputs which correspond to the protected class, and comparing statistics generated for the remainder of the outputs 150 with statistics generated for the portion of outputs 150. Such statistics include (but are not limited to) demographic parity, false positive rate, false negative rate, etc. Different statistical measures of bias are referred below as Classification Parity Indicators (CPI).

A simple example of bias may be as follows: higher earners tend to have lower loan default rates, and most high earners have blue hair. A decision engine utilizing artificial intelligence may therefore conclude that people with blue hair tend to have lower default rates, thereby be predisposed to approving loans to people with blue hair, increasing the sample size for blue-haired people, and slowly marginalizing out brown haired individuals. Algorithmic decisioning based on hair color, but not on key drivers of customer creditworthiness, may be perceived as discrimination. In solutions which deploy neural network models, or any other uninterpretable classifier, it is practically impossible to diagnose (i.e. identify key drivers of disparity) and address the issue, since there are no “rules” to gauge.

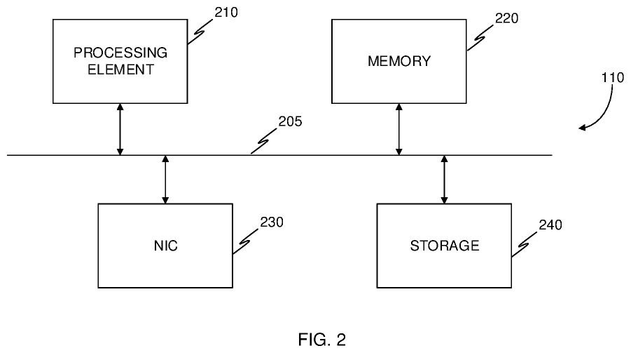

FIG. 2 is a schematic illustration of a probabilistic rule engine 110 implemented according to an embodiment. The system 110 includes at least one processing element 210, for example, a central processing unit (CPU). In an embodiment, the processing element 210 may be, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing element 210 is coupled via a bus 205 to a memory 220. The memory 220 may include a memory portion that contains instructions that when executed by the processing element 210 performs the method described in more detail herein. The memory 220 may be further used as a working scratch pad for the processing element 210, a temporary storage, and others, as the case may be. The memory 220 may be a volatile memory such as, but not limited to random access memory (RAM), or non-volatile memory (NVM), such as, but not limited to, Flash memory.

The processing element 210 may be coupled to a network interface controller (NIC) 230. The NIC 230 may be operative to provide connectivity between the processing element 210 and a network. In an embodiment, the network may be configured to provide connectivity of various sorts, as may be necessary, including but not limited to, wired and/or wireless connectivity, including, for example, local area network (LAN), wide area network (WAN), metro area network (MAN), worldwide web (WWW), Internet, and any combination thereof, as well as cellular connectivity. The processing element 210 may be further coupled with a storage 240. Storage 240 may be used for the purpose of holding a copy of the method executed in accordance with the disclosed technique. The storage 240 may be further used for storing a plurality of rules, such as rules 140 described in more detail with respect to FIG. 1 above.

It should be understood that the PRE 110 may be implemented as a physical machine, a virtual machine, in a cloud based computing environment and the like. The processing element 210 and/or the memory 220 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described in further detail herein.

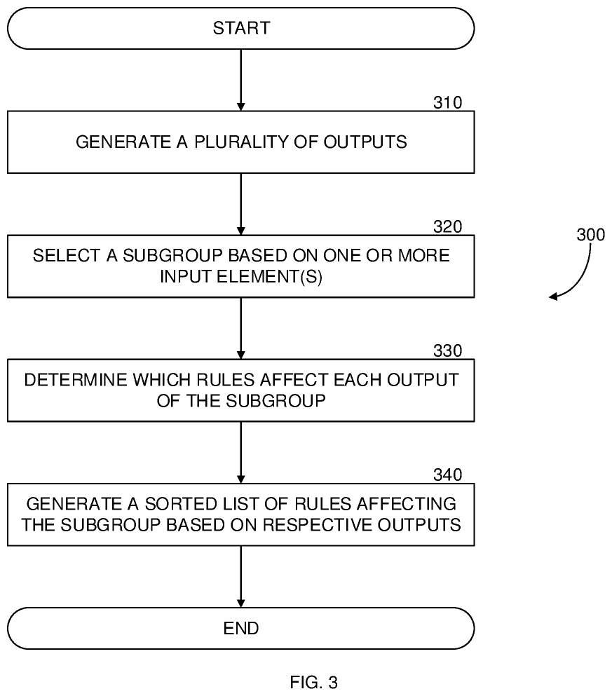

FIG. 3 is an example flowchart 300 of a method for identifying and reducing bias (i.e. classification disparity) in a probabilistic rule based decision engine, implemented in accordance with an embodiment.

At S310 a plurality of outputs 150 are generated by a probabilistic rule based decision engine, such as PRE 110 of FIG. 1 above. Each of the outputs 150 corresponds to a unique input vector 120, 122. The plurality of outputs 150 may be stored, along with an association to an input vector 120, 122, in a storage device, such as storage 240 of FIG. 2.

At S320 a subgroup of input vectors 120, 122 is selected, based on at least one common element that is common to each of the selected subgroup of input vectors. In some embodiments, the subgroup may have a plurality of common elements. In certain embodiments, a common element may be an element of identical value, an element having a value within a predefined range, or an element with an upper or lower threshold. In certain embodiments, the element may be an element of the input vector 120, the output 150, or a combination thereof. An element may be a field representing data of a certain type. For example, ‘income’ may be a data element of an input vector, which has a numerical value, and ‘gender’ may be a data element of an input vector, which has a string or character value.

At S330 a determination is made for each output 150 corresponding to an input of the subgroup, to determine which rules 140 affected the output generation. In the PRE 110, each rule 140 is applied to each input 120. However, not every rule 140 will affect the generated output 150. Likewise, not every rule 140 which has an effect will necessarily have an identical impact. In an embodiment, by subtracting the impacts of the rules 140 for the selected group and for the complementary data set, one determines the differential impact of the rules 140, (e.g. by applying every rule other than a certain rule on an input, the effect on an output may be determined). If an output does not change, or changes within a predefined value threshold, a rule may be determined to not have effect on the output generation.

At S340 a list is generated and sorted according to which rules 140 the PRE-determined had the highest differential impact on the generated output. By determining which rules 140 have the highest differential impact on the output for a certain subgroup, it may be possible to adjust the weight of this rule to correct for bias, if such was found to exist. In an embodiment, the PRE may request a user input to determine which rules 140 (if at all) should have their weights changed and the value(s) by which the weights should change. In another embodiment, the PRE may determine a weight values automatically, to improve the target classification parity indicator (CPI).

In an embodiment, optimizing bias may reduce disparity in false positive rate, in another embodiment, optimizing bias may equate to reducing disparity in false negative rate. In another embodiment, both the disparity in false positive rate and false negative rate may be reduced. In another embodiment a plurality of CPIs may be improved simultaneously.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for detecting and correcting of a statistical bias, comprising:
generating a plurality of outputs by a probabilistic rule engine (PRE), each of the plurality of outputs corresponding to an input vector;
selecting a group of outputs from the plurality of outputs;
determining by the PRE at least one rule, the at least one rule having an impact as measured by a weight of the at least one rule on the output of the group of outputs; and
generating a list of the at least one rule sorted by the weight of the at least one rule.

2. The method of claim 1, further comprising:
determining a rule from the at least one rule that has a highest differential impact on the generated plurality of outputs.

3. The method of claim 2, further comprising:
adjusting the weight of the at least one rule based on the rule determined to have the highest differential impact to correct the bias.

4. The method of claim 3, further comprising:
receiving a user input to determine which of the weight of the at least one rule is to be changed.

5. The method of claim 3, further comprising:
determining by the PRE an adjustment weight value to be applied to the weight of the at least one rule.

6. The method of claim 1, wherein the input vector further includes a plurality of elements.

7. The method of claim 1, wherein the group of outputs further includes a corresponding input vector having at least an element common to each of the corresponding input vector.

8. The method of claim 1, wherein the element common to each of the corresponding input vector includes an element of an identical value or a value within a predefined range.

9. The method of claim 1, wherein the element common to each of the corresponding input vector includes an element with one of an upper threshold or a lower threshold.

10. The method of claim 1, further comprising:
determining a differential impact for the at least one rule, the differential impact determined by subtracting the impact of the at least one rule corresponding to the selected group of outputs.

11. The method of claim 1, wherein the bias is determined for statistics generated for a portion of outputs, wherein the statistics include demographic parity, false positive rate, false negative rate, etc. Different statistical measures of bias are referred below as Classification Parity Indicators (CPI).

12. A non-transitory computer readable medium having stored thereon instructions for causing a processing circuitry to execute a process, the process comprising:
generating a plurality of outputs by a probabilistic rule engine (PRE), each of the plurality of outputs corresponding to an input vector;
selecting a group of outputs from the plurality of outputs;
determining by the PRE at least one rule, the at least one rule having an impact as measured by a weight of the at least one rule on the output of the group of outputs; and
generating a list of the at least one rule sorted by the weight of the at least one rule.

13. A system for detecting and correcting of a statistical bias, comprising:
a processing circuitry; and
a memory, the memory containing instructions that, when executed by the processing circuitry, configure the system to:
generate a plurality of outputs by a probabilistic rule engine (PRE), each of the plurality of outputs corresponding to an input vector;
select a group of outputs from the plurality of outputs;
determine by the PRE at least one rule, the at least one rule having an impact as measured by a weight of the at least one rule on the output of the group of outputs; and
generate a list of the at least one rule sorted by the weight of the at least one rule.

14. The system of claim 13, wherein the system is further configured:
determine a rule from the at least one rule that has a highest differential impact on the generated plurality of outputs.

15. The system of claim 13, wherein the system is further configured:
adjust the weight of the at least one rule based on the rule determined to have the highest differential impact to correct the bias.

16. The system of claim 15, wherein the system is further configured:
receiving a user input to determine which of the weight of the at least one rule is to be changed.

17. The system of claim 15, wherein the system is further configured:
determining by the PRE an adjustment weight value to be applied to the weight of the at least one rule.

18. The system of claim 13, wherein the input vector further includes a plurality of elements.

19. The system of claim 13, wherein the group of outputs further includes a corresponding input vector having at least an element common to each of the corresponding input vector.

20. The system of claim 13, wherein the element common to each of the corresponding input vector includes an element of an identical value or a value within a predefined range.

21. The system of claim 13, wherein the element common to each of the corresponding input vector includes an element with one of an upper threshold or a lower threshold.

22. The system of claim 1, wherein the system is further configured:
determine a differential impact for the at least one rule, the differential impact determined by subtracting the impact of the at least one rule corresponding to the selected group of outputs.
